(19) United States
(12) Patent Application Publication
(10) Pub. No.: US 2007/0011053 A1
(43) Pub. Date: Jan. 11, 2007

(54) Method and system for automating inventory management in a supply chain

(75) Inventor: Chin Kok Yap, YCH Distripark (SG)

Correspondence Address: SUGHRUE MION, PLLC, 2100 PENNSYLVANIA AVENUE, N.W., SUITE 800, WASHINGTON, DC, 20037, US

(73) Assignee: CHIN KOK YAP, YCH Distripark (SG)

(21) Appl. No.: 10/563,240

(22) PCT Filed: Apr. 16, 2004
(86) PCT No.: PCT/SG04/00097

§ 371 Date: Jul. 24, 2006

(30) Foreign Application Priority Data
Jul. 2, 2003 (SG) 200303786-8

(51) Int. Cl. G06Q 20/00

(52) U.S. Cl. 705/22

(57) ABSTRACT

The present invention relates to a method of calculating and comparing the levels of inventory to a stored set of parameters, triggering shipment and/or call for shipment/orders, automatic ordering of specific inventory and calculation of freight, shipment documentation processing & transportation costs based on the said order being triggered.

### FIELD OF THE INVENTION

The present invention relates to a method of calculating and comparing the levels of inventory to a stored set of parameters, triggering shipment and/or call for shipment/orders, automatic ordering of specific inventory and calculation of freight, shipment documentation processing & transportation costs based on the said order being triggered.

It is no longer simply a efficient supply chain that extrudes cost and operational advantages for manufacturers, suppliers and just about any business organization that relies directly or indirectly on such supply chain lines.

But rather, the introduction of automated processes that are independent of human intervention will add another dimension to the supply chain's ability to reap efficiency benefits.

For example, shipment documentation & processing is now a manual (although there are already efforts to semi-automate them) task, dependent on the actions of human operators (such as to approve of the need to order from suppliers more inventory).

In many instances, such processes can actually be fully automatic, so long as such processes meet several rules based on the level of inventory and its forecast of balances.

In such circumstances, automated processes can also provide a crucial link to existing supply chain software, processing systems, third party shipment information servers etc.

If ordering for more inventory based on specific rules is made automatic, the ordering can also provide a basis for shipment documentation to be simultaneously via electronic means, thereby reducing the latent time between order being trigger to a supplier and order-related documentation being prepared and ready for freight & transportation approval, cost estimate etc.

### SUMMARY OF THE INVENTION

It is the object of the present invention for a method of calculating and comparing the levels of inventory to a stored set of parameters, triggering shipment and/or call for shipment/orders, automatic ordering of specific inventory and calculation of freight, shipment documentation processing & transportation costs based on the said order being triggered.

The invention consist of some basic components as follows:

1. Inventory tracking and forecasting module

2. Multiple location visibility of inventory upon trigger/rule activation

3. Electronic ordering of inventory and automatic documentation processing and cost of transportation/freight calculation

Inventory Tracking and Forecasting Module

The invention has a rule-based system whereby inventory levels are classified according to the following classes;

Minimum stock level (MSL)

Critical stock level (CSL)

Current stock committed by single supplier (CSGL)

Multiple supplier commitment level (MSCL)

In the first embodiment of the present invention, the system will accept electronic input of data relating to the mentioned forecast data (Minimum, critical stock levels & multiple supplier commitment level), and generate a result or output data based on the following manner;
CSGL−MSL=CSL
Where CSL(1)+CSL(2)+CSL(3)=MSCL

Preferably, each CSL derived will be added to other values that are obtained from other suppliers within a pre-determined database of suppliers to a single or group of manufacturers.

The said system whereby inventory levels are calculated can be in a XML formatted document that is then stored on a suitable server that is capable of allowing a registered computer account to view the consolidated or entire XML document via a electronic communications network such as the Internet.

This is preferably secured with a connection between the computer account and the said server via a SSL encrypted communications link via the Internet.

Multiple Location Visibility of Inventory Upon Trigger/Rule Activation

The present invention can, upon several conditions that are stored onto a computer server (via a electronic database), compare and calculate the output values obtained, and generate a electronic signal to cause a suitable software program to display the contents of the values derived from the data inputs.

Electronic Ordering of Inventory and Automatic Documentation Processing and Cost of Transportation/Freight Calculation

The present invention can allow for the generated output values to immediately look for another database containing detailed specifications on each physical component of the inventory concerned.

Upon the collection of detailed specifications of each inventory component that corresponds to whatever short-fall and/or order requirement that is the result of the said value calculation, the present invention can make use of the said specifications to calculate the cost and rates of transportation and other related logistics and handling charges needed to order and transport the said inventory from a named seller to a designated collection hub.

### BRIEF DESCRIPTION OF THE DRAWINGS

In order that the invention may be more clearly ascertained, preferred embodiments will now be described, by way of example, with reference to the accompanying drawings, in which:

FIG. 1 is a schematic view of the entire process whereby a forecast of inventory levels required by a customer will be automatically fed into an electronic system which will in turn calculate the level of inventory available in all registered storage facilities, and compute any excess or shortfall levels for escalation to another connected electronic system for further action.

FIG. 2 is a diagram showing how the electronic system can determine the level of inventory that should be ordered from suppliers connected to the said system under the condition whereby the forecasted level of inventory required by the customer is assumed greater than the critical and/or minimum level of inventory.

FIG. 3 is a systemic diagram showing how the said electronic system will trigger an electronic order from any number of registered suppliers more inventory composing of any number of individual items or components automatically upon the calculation of a shortfall of inventory that is required.

FIG. 4 is a systemic diagram illustrating the method and process whereby the automatic ordering action by the said system will cause any number of connected computer devices to calculate the estimated cost of shipping a specific number or level of inventory from any number of registered suppliers to any number of storage locations that will subsequently make available the said inventory to the customer based on the system's ordering specifications.

### DETAILED DESCRIPTION OF THE PREFERRED EMBODIMENTS

According to a first embodiment of the present invention, there is provided a method of calculating and comparing the levels of inventory to a stored set of parameters, triggering shipment and/or call for shipment/orders, automatic ordering of specific inventory and calculation of freight, shipment documentation processing & transportation costs based on the said order being triggered.

The implementation of the first embodiment is via a series of apparatus that includes the following;
A master remote server comprising of a database, operating system & software application capable of transmitting and receiving TCP/IP data (such as an Internet browser);
A server registry that contains another separate database detailing information such as freight rates published by another third party, shipping and transportation data etc.;
A inventory registry that contains another separate database detailing information relating to inventory levels and/or availability as electronically published by any registered user or other remote server that is connected to the said inventory registry;

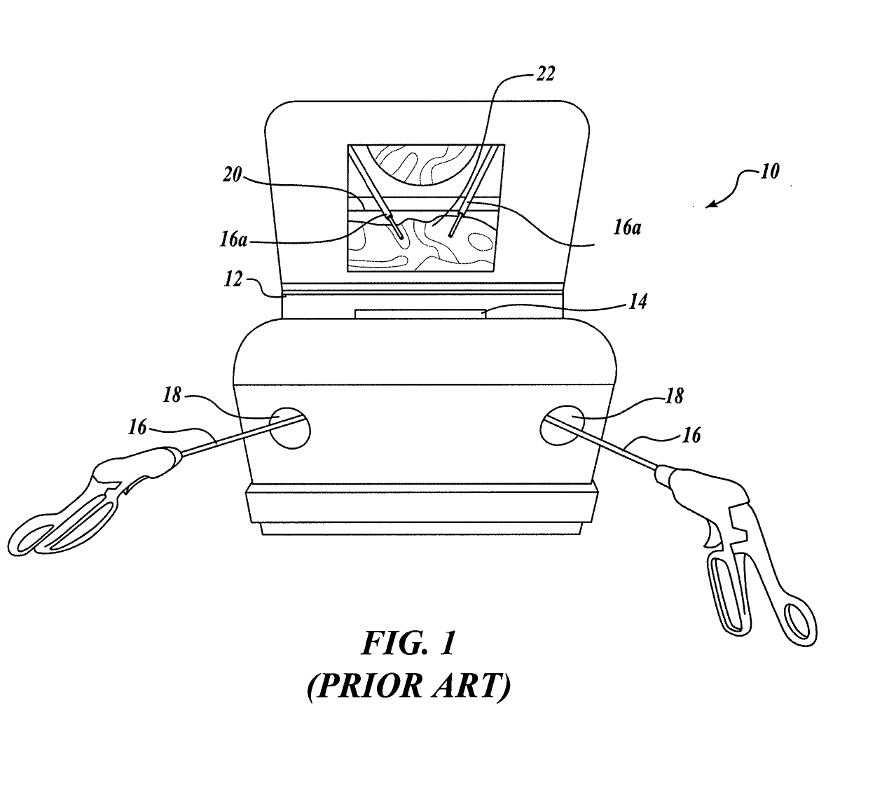

With reference to FIG. 1, and according to the second preferred embodiment of the present invention, a party will route (01) XML data (or data in other formats such as EDI, text file, HTML, SQL, DHTML etc.) to a master remote server that will perform authentication with both server registry and inventory registry prior to submitting said XML data to either registry for further processing.

The server registry will perform a look-up from at least 1 database containing (02) a 13 week rolling forecast data, and perform a pre-determined set of operations and/or parameters as stored in the said server and/or registry.

The said registry will subtract the (02) 13 week forecast data from a (03) critical stock level data that is stored onto either the said registry or another database residing within another inventory registry and/or remote server.

The subtraction will yield both the (04) receiving status buffer data and (05) automatic stock position data, of which both will determine the actions the present invention will perform onto another series of remote servers connected to any number of registered users.

According to the third preferred embodiment of the present invention, the master remote server may make reference to data parameters stored on the said registry server (by matching database data to received XML data for processing using database operations such as SQL functions including but not limited to search, add, subtract, compare etc.).

In this preferred embodiment, the master remote server may make use of information received to further process using stored database parameters to generate a set of action messages for implementation by the same master remote server or any connected information system.

The master remote server may also make use of secondary data from any connected database containing information such as shipping information, freight rates, inventory forecast data etc. to calculate and yield a final (07) consumption status report of the supply chain under monitoring by the present invention.

According to the fourth preferred embodiment of the present invention, the (07) consumption report data generated by the said master remote server will be used to further process by sending electronic purchasing information to a third party such as inventory suppliers and/or customers (consignees).

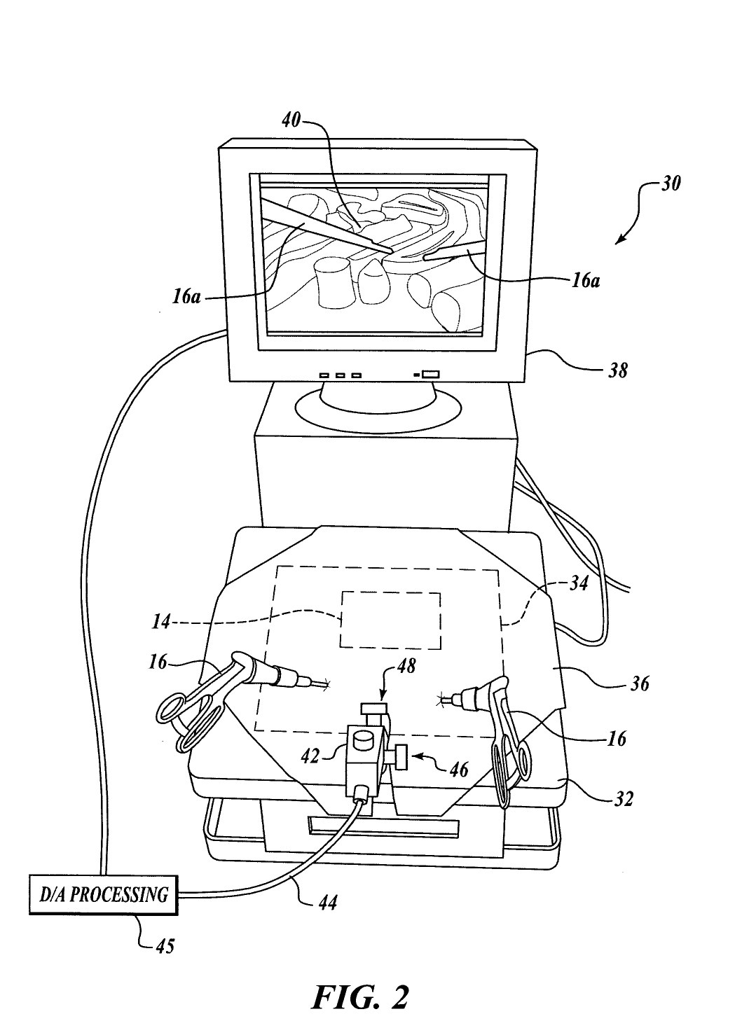

With reference to FIG. 2, and according to the third preferred embodiment of the present invention, the master remote server may cause any number of connected servers to send and receive data for execution with another third party, such as triggering inventory ordering or generation of stoppage of additional orders directly to a predetermined number of suppliers adapted to receive said orders.

Using (A1) a 13 week forecast information of the expected quantity and details of inventory material required by a single or group of customers connected to the operator of the present invention, the master remote server will also compare the total forecast data to (A2) critical stock level and (A3) receiving status buffer to arrive at a order quantity that would be suitable for triggering to said suppliers.

The master remote server may build a database containing the following data for further processing in order to perform and implement the third embodiment of the present invention;

A master remote server;

Main server memory;

At least 1 permanent data storage device;

With reference to FIG. 2, said server shall load (A4) data representing level of forecast inventory required according to stored parameters that will determine the said level according to further data that may be provided by said server or any number of separate processing systems.

The (A4) data may be compared against the minimum level of inventory required (MSL), critical stock level (CSL) and current stock committed by single supplier (CSGL) data.

With reference to FIG. 2, the secondary data (A5, A6 and A7) are matched against (A4) forecast inventory data, and resulting information (whether there is excessive stock levels or shortage due to insufficient buffer stock) will determine the triggering actions to be transmitted by the master remote server to either a third party processing system or another server connected to the said master server for further electronic processing including but not limited to inventory purchaser orders, inventory stoppage instructions etc.

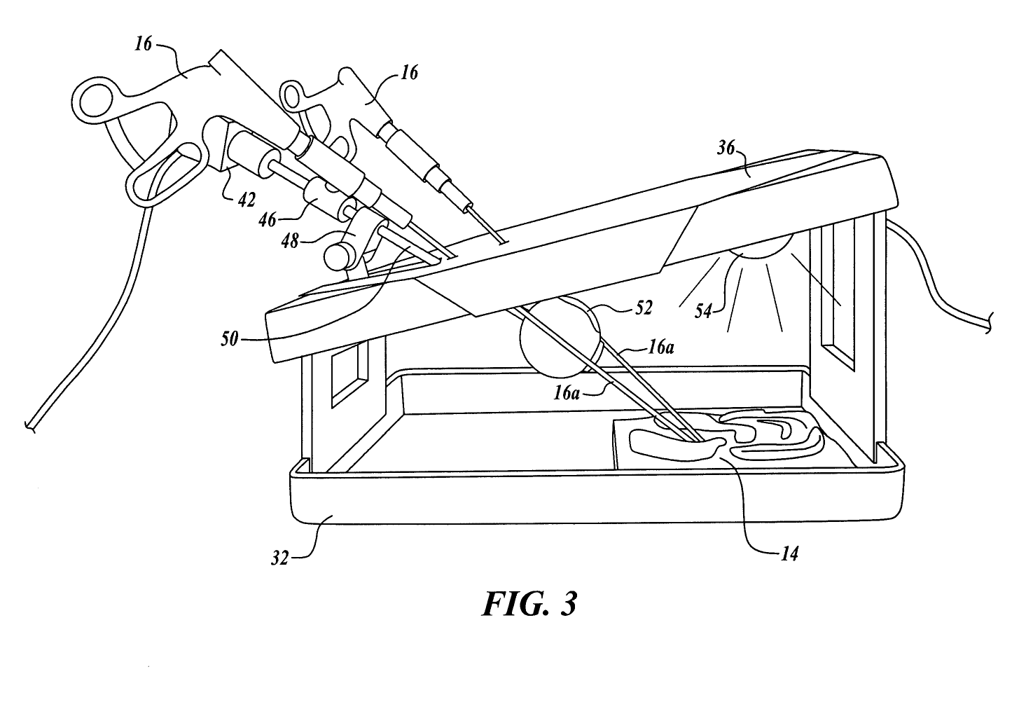

With reference to FIG. 3, the level of (B4) buffer stock, combined with the minimum stock level (B2) is inadequate to meet the total level of forecast inventory required (B1), thereby causing the said master remote server to relay or trigger ordering of a calculated level of inventory (materials or parts) from a pre-determined group of inventory suppliers.

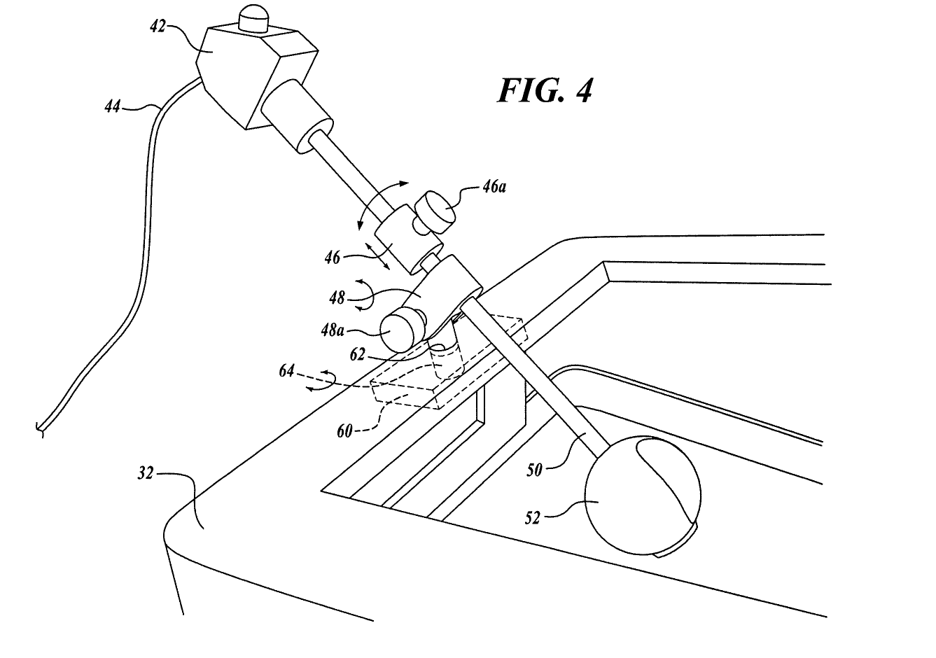

With reference to FIG. 4, and according to the fourth preferred embodiment of the present invention, the master remote server will determine the level of buffer inventory to order (10), thereby triggering a order message from the said server to a ordering module (20), causing ordering module (20) to match each said order message (10) to each order or part specification number from a specifications database (30), further allowing said database to consolidate all part numbers and/or inventory specification/material number/ID to be included into a look-up file (40).

The (40) look-up file will composed of message data including;
File header information
Date and file creation data
File owner
File message DTD
Message tag and/or XML tags
Inventory specification message
Inventory specification tag
File end

The present invention will also make use of the (40) look-up file to generate a separate (50) shipping, transportation and freight transcript file that will be used to calculate and provide a scope of expenses that is required for the ordering of the said inventory.

Said transcript (50) will cause master remote server to generate a file containing shipping rates and may apply additional rates to further incorporate said additional rates with said shipping rates into another document for transmission to a third party.

The present invention will therefore be capable of automatically operating the entire supply chain ordering, matching, inventory tracking, transport, storage, freight and shipping events by means of accepting suitable data from any registered user or processing system connected to the said master remote server.

Modifications within the spirit and scope of the invention may readily be effected by persons skilled in the art. It is to be understood, therefore, that this invention is not limited to the particular embodiments described by way of example hereinabove.

The claims defining the invention are as follows;

1. A method for a inventory management system to receive an electronic order from a registered user to either send user specified material to a connected warehouse or to extract a user specified material from the said warehouse, further triggering the said system to compute and output the current cost of the order by calculating the freight and carriage costs associated with the said order.

2. A method as claimed in claim 1, including allowing the user to define to the inventory management system to calculate the associated freight and carriage costs according to the user's preference in a predetermined budget range being stored within the said system

3. A method for a inventory management system to be connected to at least 1 warehouse allowing the user of the said system to electronically send an order to trigger a retrieval of a user specified inventory item for shipment to a user specified destination according to a user specified budget for the shipment costs associated with the said triggered activity

4. A method for a inventory management system to be connected to at least 1 warehouse allowing the user of the said system to electronically send an order to trigger an acceptance and shipment of incoming, user specified inventory from a user specified location according to a user specified budget for the shipment costs associated with the said triggered activity

5. A method for a computer implemented process where registered users within a inventory management system can input inventory quantity incoming to a connected warehouse or inventory quantity outgoing from a connected warehouse, further allowing the said system to generate a estimate of costs associated with the user's input in a suitable electronic file format

6. A method as claimed in claim 5, where the inventory management system is electronically connected to a TCP/IP based network bearing the freight, insurance and transportation costs of a predetermined list of vendor rates being updated within a predetermined time cycle stored within the said system

7. A method for a processor to be electronically connected to a warehouse, accepting electronic data to update and record the total stock of inventory items into a suitable electronic file format, comparing with any input of orders made by any registered user of the said processor, and subtracting or adding the order quantity to the said total stock value within a predetermined time cycle stored within the said processor

8. A method for determination of the total combined value of a plurality of inventory from multiple inventory hubs to a single physical location where said determination is to be implemented via a electronic communications network comprising of the following steps;
Single physical location to send a pull signal to a plurality of registered or predetermined inventory hubs via a connected communications network;
Said network to transmit said signal using TCP/IP as the carrier format and XML, HTML, ASCII text, digital binary bits as the primary data format;
Said signal may include additional instructions where the manner of which each predetermined inventory, inventory lot, inventory SKU, material part number, material lot number, material code number is to be merged at a particular physical transit point, or how said instructions will determine the manner by which a plurality of inventory material is to be merged into a single assembled or semi-assembled collection of inventory prior to physical delivery to a ultimate physical destination hub

9. A system for implementing an electronic communications network designed for the purposes of collecting the rates, prices and other transactional details relating to shipping, transportation and freight agents/parties, storing said data into a database connected to the said network, comparing said database to a plurality of electronic requests for quotation of the said shipping, transportation and freight details by any registered user of the said network, and finally computing and matching the said request to one or more optimized quotation answers

10. A system as claimed in claim 9, where said electronic requests are structured with multiple parameters of which each registered user can elect in order to determine the manner by which the said network will communicate with the said database in order to arrive at one or more optimized quotation request answers

11. A system as claimed in claims 9 and 10, where said electronic requests are structured to allow each registered user to elect the manner by which the said network can communicate with the said database in order to arrive at one or more optimized quotation request answer, either by the lowest cost, best or fastest performance or delivery, medium cost with medium performance or delivery, or service agent with a predetermined level of experience, lowest cost of insurance, greatest cost of insurance, best cost for a elected level of performance or delivery, best cost for a elected level of performance or delivery within a user specified variance

12. A system for a singular material hub to be present in the domain of an electronic network, where the said hub may comprise of separate and distinct physical locations which may be unknown to a registered user of the said network, for the purpose of reducing material transport routing and planning requirements by the said user

13. A system for a singular material hub to be present within an electronic communications network that is connected to at least one supply chain intermediary, allowing the said intermediary to present to a plurality of registered users of the said hub a singular point of sending inventory materials for storage, transit, warehousing, merging, stocking, distribution, assembly, manufacture, processing, shipment and/or transport, where said hub may physically be composed of more than one geographical location, which may be unknown to the said user, for the purposes of reducing route and related material planning requirements by the said user

14. A system for a inventory material hub to accept material input from a plurality of auxiliary physical storage units for the purpose of providing by means of the said hub, a staging area for the said material from the said units to be assembled or be packed or processed into a single package for routing to a final location by which the flow of the said method shall be governed by a series of instructions that are unique and are carried over a uniform electronic communications network between the said hub, said storage units and the said final location

15. A method as claimed in claim 14, where said instruction will include a routing number, routing SKU and routing code of which the said information shall be processed by a designated processor in accordance with a stored set of electronic parameters within a connected database

16. A method as claimed in claims 14, 15, where said instruction will use the routing code or another alternative data set to determine the total quantity of each material SKU that is predetermined to arrive at the said material hub, and compare to the total cumulative SKU quantity required for each designated assembled or processed packaged that is to be routed to the said final location

17. A method as claimed in claim 16, where a designated processor shall determine and calculate the total quantity required for each of the said material SKU that is to arrive at the said material hub, in order to fulfil the total cumulative SKU quantity required for each designated assembled or processed package that is to be routed to the said final location

18. A method as claimed in claims 14, 15, 16, 17, were any excess quantity of material to arrive at the said material hub shall be deemed not critical and be tagged by the communications network for either storage at the said material hub, re-routing back to its original place of shipment, or be tagged for stoppage prior to shipment to the said material hub

19. A method and apparatus for an electronic network to be connected to a plurality of material hubs, where each said material hub shall comprise of at least one processor and authentication unit, for the purposes of allowing a physical delivery of material, goods or inventory moved from one said hub to another to be authenticated and be confirmed between the recipient of the recipient material hub and the sending party of the other material hub by means of a portable electronic device capable of accepting the said authentication and delivery confirmation, of which the said device is also connected to the said communications network

20. A method and apparatus as claimed in claim 19, where the said delivery confirmation and authentication can be implemented on the said device where the physical delivery of material begins from one registered material hub and ends at a location that is not a material hub but is a designated location of delivery that is agreed between the sender of the said material and the recipient of the said material

21. A method and apparatus as claimed in claim 19, 20, where the recipient of the said material do not need to operate or be equipped with an authentication and confirmation processor unit

22. A system as claimed in claim 5, where the electronic procurement and inventory management system shall comprise of the following;
Operator and controller of communications network within the said system;
A registered user having an unique electronic identity stored on the said network;
Each said user having the means to operate the said system by inputting inventory material forecast levels of consumption;
Each said user having the means to operate the said system by inputting multiple instances of the said user's expected or forecasted quantity of materials that is required;
Said system allowing the said expected quantity to be transmitted to a designated number of related parties (other users) for triggering of an action;
Said system allowing each related party to view the expected forecast quantity that relates to the specific range of materials that the said party had been assigned by the first user to supply;
Said system allowing the said party to trigger shipment and delivery of the said specific range of materials and the actual quantity the said party is able to fulfil;
Said system enabling to trigger a overview report and shortage notification message to the first said user upon consolidation from any number of registered said parties who had provided with a shipment, delivery and quantity response

23. A system for an electronic procurement and inventory management application that is processor-implemented over an electronic communications network, for the purposes of allowing input of specific manufacturing procurement and material requirement data from 1 or more client user, and sending said data to a range of client suppliers related and registered to the said user, receiving from the said suppliers appropriate responses, and generating a consolidated reporting file that provides the said client user with information relating to the overall ability of the said client user to fulfil the total procurement and material requirement as originally input by the said client user

24. A system as claimed in claim 23, where said system shall also allow client user to input the total quantity of finished or processed or manufactured items that is demanded within a client-specified time schedule

25. A system as claimed in claims 23, 24, where said system shall store the total quantity as input from the said client user, and perform a database look-up in order to retrieve all registered part or component suppliers that are required in order to allow the said client's demand of a specific quantity of finished item to be fulfilled

26. A system as claimed in claims 23, 24, and 25, where said system shall retrieve all sub-component items required for each said supplier and calculate the total quantity that is required of each said supplier in order to fulfill the said client's demand

27. A system as claimed in claims 23, 24, 25, 26, where said system will allow each said supplier to return an electronic response as to the availability of the said supplier's components

28. A system as claimed in claims 23, 24, 25, 26, 27, where said system shall receive all said supplier's responses via the said electronic communications network, and match the said responses to a connected database to calculate and derive a total possible quantity of finished items that can be supplied to the said client user

29. A system for an inventory processing unit to accept electronic rules from a registered device and/or user, making use of the said rules to determine the manner by which a specific quantity of inventory material should be stored at a plurality of physical storage locations

30. A system for an inventory processing unit to perform electronic control and inventory administration comprising the following steps;
Displaying to a plurality of registered users a single storage facility,
Having the inventory processing unit be connected to a plurality of storage facilities,
Having the said unit display only a single storage facility regardless of the actual number of physical storage facilities having being connected to the said unit,
Displaying and allowing inventory control and administration to be performed, managed and operated via the said single displayed facility to a registered user or a plurality of said users.

31. A system for an inventory processing unit to be electronically connected to a plurality of warehouses and/or storage facilities, further displaying in a suitable form to a plurality of users a single warehouse representing the total stock of all inventory physically present from all said connected warehouses.

32. A system as claimed in claims 30 and 31, where said inventory processing unit will display a single warehouse to at least 1 user, allowing the said user to activate and operate the movement and control of inventory material

33. A system for an inventory processing unit to be electronically connected to a plurality of warehouses and/or storage facilities, allowing said unit to record the individual inventory material details and quantity from each said warehouses, further displaying to at least 1 user the total consolidated detail and quantity from the said warehouses

34. A system as claimed in claim 33, where said unit displays to the said user a single representation of a warehouse irregardless of the actual number of warehouses actually being connected to the said unit

35. A system for an inventory processing unit to be electronically connected to a plurality of warehouses and/or storage facilities, allowing said unit to record the individual inventory material details and quantity from each connected warehouse, presenting and displaying to at least 1 user the total detail and quantity derived from all said connected warehouses

36. A system for an inventory processing unit to receive electronic orders from at least 1 user of the said unit, to move and/or control the movement of a specified quantity and detail of inventory material from a single designated storage hub being displayed to the said user, to a user designated destination, comprising the following steps;
Inventory processing unit displaying to user a single designated storage hub,
Inventory processing unit being connected to a plurality of storage hubs,
Inventory processing unit accepting an electronic order from the user to move a specific quantity of a designated inventory material type to a user specified destination
Inventory processing unit polling the said connected hubs the total quantity of inventory material being designated by the user that is available
Creating and generating a list detailing the quantity of designated inventory material to extract from each said connected hub to match the said order being given by the said user to the inventory processing unit

37. A system for an inventory processing unit to be connected to a plurality of warehouses, allowing to display to a registered user a single designated virtual warehouse, further allowing the said user to activate via the single virtual warehouse the movement of a user specified inventory item and its related quantity

38. A system as claimed in claim 37, where said virtual warehouse receives an electronic order from a user to move a specific quantity and type of inventory item from the said virtual warehouse to a user designated destination, comprising of the following steps;
Receiving an electronic order from the said user;
Polling all connected physical warehouses to get the quantity of the specified inventory item available;
Generating and sending to each said physical warehouses the individual, incremental quantity to extract to match the said electronic order

39. A system for a inventory processing unit to be connected electronically to a series of designated warehouses, further displaying the contents of each individual warehouse into a single, consolidated virtual warehouse to a registered user

40. A system for a inventory processing unit to be connected electronically to a series of designated warehouses, displaying a consolidated view of the contents of all said warehouses into a single virtual warehouse to a user, further allowing the user to activate the movement of a specified inventory item of a specified quantity without the knowledge of the individual quantity available at each of the individual designated warehouses

41. A system for a inventory processing unit to be connected electronically to a series of designated warehouses, allowing a designated user to operate and control predetermined inventory items at any of the said warehouses via a single virtual warehouse identity being displayed to the said user

42. A system for a inventory processing unit to be connected electronically to a series of designated warehouses, allowing a designated user to operate, control and assign ownership rights of a predetermined inventory item range at any of the said warehouses via a single virtual warehouse identity and/or object being displayed to the said user

43. A system for a inventory processing unit to be connected electronically to a series of designated warehouses, displaying a predetermined range of inventory items from each individual warehouse into a single virtual warehouse identity and/or object to a user

44. A system as claimed in claim 43, where said user may be given authorization to send to the inventory processing unit electronic orders to transfer, move or stock a user specified quantity and type of inventory item from the displayed virtual warehouse to a user specified destination

45. A system as claimed in claims 29 to claims 44, where a user may also input to the inventory processing unit an order to receive a user specified quantity and type of inventory items from any external location not connected to the virtual warehouse identity for storage into any of the connected physical warehouses to the said virtual warehouse

46. A system as claimed in claims 29 to claims 44, where a user may also input to the inventory processing unit an order to store a user specified quantity and type of inventory items from a user specified location into the virtual warehouse, further triggering the inventory processing unit to determine the incremental quantity of incoming said items to store at each of the connected physical warehouses

47. A system for a inventory processing unit to be connected electronically to a series of warehouses in multiple geographical locations, displaying to a user a single virtual warehouse identity that is a representation of the said connected warehouses

48. A system for a inventory processing unit to be connected electronically to a series of warehouses in multiple geographical locations, displaying to a user a single virtual warehouse identity that is a representation of the said connected warehouses, further allowing the user to send orders to the inventory processing unit to either extract or store a user specified quantity and type of inventory item

49. A system as claimed in claim 48, where the inventory processing unit may also request from the user to specify any additional storage rules or parameters other than the order to either stock up or pare down a user specified inventory item

50. A system as claimed in claim 49 where the inventory processing unit will make use of the said rules or parameters being input to determine the manner by which individual quantities to be stocked or extracted from each said connected warehouses are implemented

51. A method and apparatus for a inventory management system to be electronically connected to a plurality of warehouses, allowing the said system to also receive the status information from each said warehouse of its contents, further allowing the system to display the collective content information and its related data to a single electronic entity termed a virtual warehouse and/or hub

52. A method and apparatus for a inventory management system to be electronically connected to a plurality of warehouses, allowing the said system to also receive the status information from each said warehouses, further allowing the said system to display to a plurality of users a single virtual hub and/or warehouse that reflects the collective information and/or data that is a representation of the said connected warehouses

53. A method and apparatus for a inventory management system to be electronically connected to a plurality of warehouses, allowing the said system to display the collective information and/or data derived from the said connected warehouses to a single representation of a virtual material hub and/or warehouse

54. A method and apparatus as claimed in claims 51 to 53, where the inventory management system receives an electronic order from a user to receive inventory material from a user specified location into the virtual warehouse

55. A method and apparatus as claimed in claims 51-54, where upon receiving the said electronic order from the user, the inventory management system will electronically generate the individual quantity of the said material to be stocked at each system designated warehouse dependent on a stored set of computer driven rules and parameters within the said inventory management system

56. A method and apparatus as claimed in claims 51 to 53, where the inventory management system receives an electronic order from a user to extract user specified inventory material from the virtual warehouse to a user specified location

57. A method and apparatus as claimed in claim 56, where upon receiving the said electronic order from the user, the inventory management system will electronically generate the individual quantity of the said material to be extracted at each system designated warehouse dependent on a stored set of computer driven rules and parameters within the said inventory management system

58. A system as claimed in claims 51 to 57, where the inventory management system will poll from all its connected warehouses on the availability of warehousing space and/or user specified inventory material stock levels prior to generating a list of said connected warehouses where further stock extraction, and/or stock loading will be executed

59. A system as claimed in claims 51 to 58, where the inventory management system will generate a list of said connected warehouses that are targeted by the said system for further action depending on the stored parameters within the said system

60. A system as claimed in claim 59, where the inventory management system will further generate an electronic order to each said targeted warehouses on the said generated list to either receive (stock up) or extract (draw down) a user specified inventory item, quantity, and supplementary data including SKU, serial numbers, volumetric data, ISO identification tags, RFID numbers, product dimension data

61. A method and apparatus for a plurality of warehouses and its inventory items to be electronically connected to a computer driven computer application allowing said application to display the consolidated item details and quantity into a single electronic representation of a virtual warehouse to a user of the said application, further allowing the said user to perform inventory operations comprising of the following steps;
Allowing user to instruct the said application to extract a user specified quantity, type and detail of inventory item from the displayed virtual warehouse to a user specified destination and/or a plurality of user specified destinations,
Accepting the user instruction, having the computer application poll the cumulative total and relevant individual inventory item level available from each connected warehouse,
Comparing and computing if the user instructed quantity is below the said cumulative total available from all connected warehouses,
Generating a electronic list of individual quantity, detail and type of inventory item for extraction and shipment to a user specified destination/destinations from each connected warehouses

62. A method and apparatus for a plurality of warehouses and its inventory items to be electronically connected to a computer driven computer application allowing said application to display the consolidated item details and quantity into a single electronic representation of a virtual warehouse to a user of the said application, further allowing the said user to perform inventory operations comprising of the following steps;
Allowing user to instruct the said application to accept a user specified quantity, type and detail of inventory item from at least one user specified location for shipment and storage into the displayed virtual warehouse,
Accepting the user instruction, having the computer application poll all connected warehouses to the virtual warehouse for storage space availability,
Comparing and computing if the user instructed quantity and storage space requirement of inventory items for shipment and storage is below the cumulative total storage space available from all connected warehouses,
Generating a electronic list of individual quantity, detail and type of inventory item for shipment and storage to each of the connected warehouses

63. A method as claimed in claim 61, where the computer application may store in memory a minimum level and/or quantity of a predetermined inventory item to be present and stocked at each connected warehouse, and performing an electronic calculation in order to derive the available quantity permissible for extraction, further sending this said available quantity to the said computer application during polling, comprising of the following calculation; Where,
Total units stocked at warehouse (connected warehouse identification number Q)=X
Minimum units to maintain at warehouse (connected warehouse identification number Q)=Y And,
Y subtracted from X to yield=K(Number of units to report to computer application that is available during polling)
